(19) United States
(12) Patent Application Publication
(10) Pub. No.: US 2011/0133000 A1
(43) Pub. Date: Jun. 9, 2011

(54) DEVICE FOR DISPENSING A FLUID PRODUCT

(75) Inventor: Ludovic Petit, Vitot (FR)

(73) Assignee: VALOIS SAS, LE NEUBOURG (FR)

(21) Appl. No.: 13/003,537

(22) PCT Filed: Jul. 9, 2009
(86) PCT No.: PCT/FR09/51356

§ 371 Date: Feb. 18, 2011

(30) Foreign Application Priority Data
Jul. 10, 2008 (FR) 0854726

(51) Int. Cl. A62C 11/00; B05B 1/26; B65D 88/54

(52) U.S. Cl. 239/333; 222/321.6; 239/461

(57) ABSTRACT

A fluid dispenser device comprising: a reservoir (100); a pump (50) that defines a pump chamber (56); a first piston (51) that slides in leaktight manner between a non-dispensing position and a dispensing position; a spray head (10) including a body (11) that defines an expulsion channel (12) and that is provided with a dispenser orifice (1); a closure member (40) that is disposed in said expulsion channel (12) upstream from the dispenser orifice (1), said closure member (40) being movable between a closed position and a non-closing position; and a second piston (57) that co-operates with said closure member (40) in order to move it towards its non-closing position; wherein, in the dispensing position of the first piston (51), said pump chamber (56) is connected to the reservoir (100) in order to equalize the pressures after each actuation.

The present invention relates to a dispenser unit for a fluid dispenser. The present invention also relates to a fluid dispenser including such a dispenser unit.

The present invention relates more particularly to spray devices, in particular of the nasal type, and preferably applies to sprays incorporating a closure member for closing the dispenser orifice.

In a spray, e.g. of the nasal type, the spray head generally incorporates a spray profile that is provided upstream from the dispenser orifice, and that is adapted to cause the fluid to swirl before being expelled in spray form. In known manner, the spray profile may include one or more non-radial channels provided in the end wall of the spray head, said channels leading to a swirl chamber that is disposed immediately upstream from the dispenser orifice.

In general, an insert is disposed in the spray head firstly for substantially filling the dead volume in the expulsion channel, thus leaving only a narrow channel, and secondly for forming the end of the spray profile. An additional part forming the insert is thus necessary for making said spray profile.

The presence of a closure member upstream from the dispenser orifice also poses specific problems.

Closure members for closing the dispenser orifice of a fluid dispenser are well known in the prior art. There exist several types. A first family of closure members comprises closure members that are urged elastically towards their closed position, and that are deformed or moved by the pressure of the fluid during the dispensing stage in order to open the dispenser orifice. Such devices may comprise either closure members made of deformable material, or closure members made in the form of a piston that slides in the expulsion channel away from the dispenser orifice under the effect of the pressure exerted by the fluid. Document U.S. Pat. No. 5,806,762 discloses a deformable closure member, surrounding a rigid insert, having a closure function that is directly linked to the pressure exerted by the fluid within the device. Another family of closure members comprises closure members that are deformed mechanically by another portion of the dispenser head when the device is actuated in order to dispense a dose of fluid. In this event, the closure member is opened regardless of the pressure exerted by the fluid. Although operating correctly, such closure members present the drawback of being relatively difficult to manufacture and to assemble, and of therefore being costly. In general, the dispenser head needs to be modified in order to match the closure member, thereby also incurring an increase in the cost of manufacturing the fluid dispenser device. In addition, when the dispenser head incorporates a spray profile, the presence of the closure member generally alters the shape of said spray profile, and that is prejudicial to the quality of the spray during expulsion of the fluid.

Another problem that may occur with pumps relates to the pressure differences that are likely to form between the metering chamber and the reservoir, and that may lead to the pump becoming blocked or malfunctioning.

In addition, in order to avoid any risk of contamination of the fluid to be dispensed, it is desirable to limit contact between said fluid and metal materials. Unfortunately, pumps generally contain metal springs.

Document U.S. Pat. No. 5,348,189 describes a device that does not have a closure member. Document FR-2 815 674 describes a device that enables connection between the pump chamber and the reservoir only during priming, when the pump chamber contains mainly air.

An object of the present invention is to provide a fluid dispenser device for a fluid dispenser that does not have the above-mentioned drawbacks.

Another object of the present invention is to provide a dispenser device that is simple to manufacture and to assemble, and that does not require the dispenser head to be modified.

Another object of the present invention is to provide a fluid dispenser device that avoids any contact between the fluid to be dispensed and metal elements, such as the return spring of the pump.

Another object of the present invention is to provide a fluid dispenser device that avoids any risk of the pump becoming blocked, even after a plurality of successive actuations.

The present invention thus provides a fluid dispenser device comprising: a reservoir; a pump including a pump body that defines a pump chamber; a first piston that slides in said pump body between a non-dispensing position and a dispensing position; a spray head that is mounted on said pump and that is movable manually between a rest position, in which said first piston is in a non-dispensing position, and an actuated position, in which said first piston is moved towards its dispensing position, said spray head including a body that defines an expulsion channel and that is provided with a dispenser orifice; a closure member that is disposed in said expulsion channel of the spray head, upstream from the dispenser orifice, said closure member being movable between a closed position, in which it co-operates with said dispenser orifice in order to close it, and a non-closing position, in which it is moved away from said dispenser orifice, said closure member being urged towards its closed position in the rest position of said spray head; and a second piston that slides in said pump body, said second piston co-operating with said closure member in order to move it towards its non-closing position; wherein, in the dispensing position of the first piston, said pump chamber is connected to the reservoir in order to equalize the pressures after each actuation.

Advantageously, upstream from said dispenser orifice, said body of the spray head includes a spray profile that is adapted to spray the fluid while it is being dispensed, said spray head including a rigid insert that is disposed upstream from said spray profile and having an end surface that forms, at least in part, the end wall of said spray profile, said rigid insert being secured to said first piston.

Advantageously, said rigid insert is made integrally with said first piston.

Advantageously, said first piston includes at least one through passage enabling the fluid to pass from the inside to the outside of said first piston.

Advantageously, said closure member is disposed inside said first piston, in particular in slidable manner.

Advantageously, said second piston co-operates with said closure member at the end of actuation, when said spray head arrives in its actuated position.

Advantageously, said first piston is stationary relative to said spray head.

Advantageously, the pump includes a return spring that is disposed out of contact with the fluid.

Advantageously, the pump body includes an outer first axial sleeve and a second axial sleeve, said first piston co-operating in leaktight manner firstly with the inside of said outer axial sleeve, and secondly with the outside of said second axial sleeve.

Advantageously, said top edge of said second axial sleeve slides in leaktight manner against the inside surface of said first piston until it reaches the dispensing position of said first piston, in which position said second axial sleeve no longer co-operates in leaktight manner with said first piston, thereby connecting the metering chamber to the reservoir.

Advantageously, said pump body includes an inner third axial sleeve, said second piston co-operating in leaktight manner firstly with the inside of said second axial sleeve, and secondly with said inner third axial sleeve.

Advantageously, the return spring of the pump is disposed between said second piston and said second and third axial sleeves of the pump body.

Advantageously, said second piston includes an outer wall that co-operates in leaktight manner with the second axial sleeve of the pump body, and an inner wall that co-operates in leaktight manner with the inner third axial sleeve of the pump body, preferably inside said inner third axial sleeve.

The present invention also provides a fluid dispenser device comprising a reservoir and a dispenser unit as defined above.

Other advantages and characteristics of the invention appear more clearly from the following detailed description, given by way of non-limiting example, and with reference to the accompanying drawings, in which:

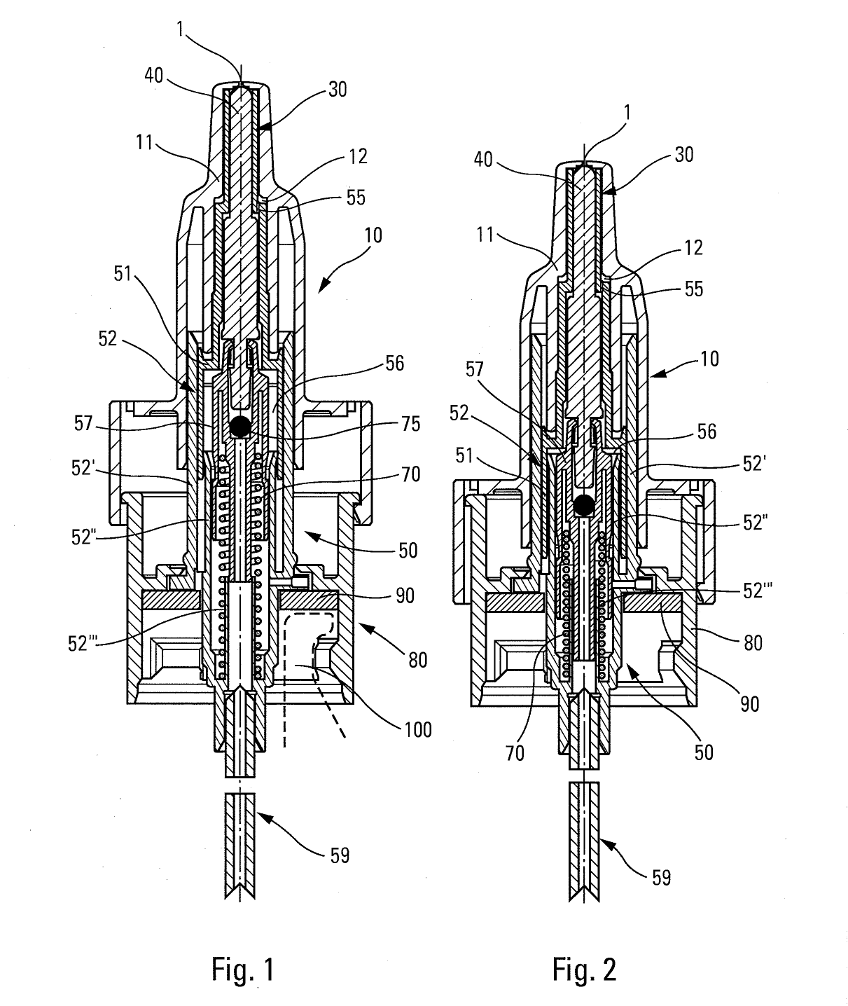

FIG. 1 is a diagrammatic section view of a dispenser device in an advantageous embodiment of the invention, in its rest position;

FIG. 2 is a view similar to the view in FIG. 1, in the actuated position; and

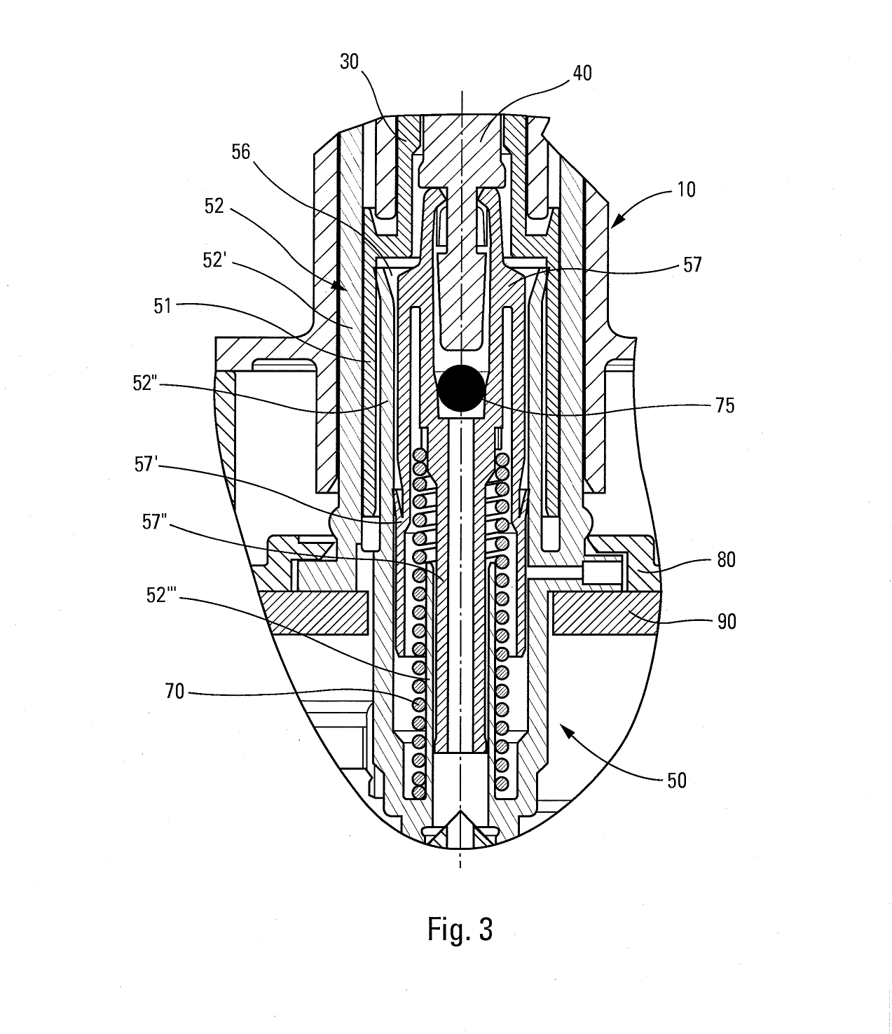

FIG. 3 is a larger-scale view of the FIG. 1 device.

The present invention relates more particularly to a dispenser device provided with a closure member. FIGS. 1 and 2 show a nasal dispenser head, but the present invention may equally well be adapted to other types of dispenser head.

The dispenser device comprises a pump 50 and a spray head 10. The pump 50 may be mounted on a reservoir 100 of which only a fraction is shown by dashes in FIG. 1. It may include a dip tube 59 that extends towards the bottom of the reservoir. Pump mounting may be by means of a fastener ring 80, with a sealing gasket 90 advantageously being interposed. The ring 80 may be a separate part, as shown in FIG. 1, or it may be formed integrally with the pump. It may be assembled in any way, e.g. by snap-fastening, by screw-fastening, or by crimping.

With reference to the figures, the dispenser head 10 includes a body 11 that defines an expulsion channel 12 that is terminated by a dispenser orifice 1. A rigid insert 30 is disposed in the expulsion channel 12 making it possible to limit the dead volume in the expulsion channel and thus define a narrow passage for the fluid, facilitating spraying from the dispenser orifice. The dispenser head includes a spray profile (not shown), preferably formed between the front face of the end wall of the spray head 10 and said insert 30, the dispenser orifice 1 thus preferably being situated at the center of said spray profile. Preferably, and in known manner, the spray profile may include non-radial swirl channels (not shown) that are connected to a swirl chamber that is disposed directly upstream from the dispenser orifice 1. The spray profile may be formed in the end wall of the head 10, or, on the contrary, in the insert 30.

The pump 50 includes a pump chamber 56 that is provided with an inlet valve 75, such as a ball in the embodiment in FIG. 1.

The pump 50 comprises a pump body 52 in which a first piston 51 slides between a rest or non-dispensing position and an end-of-actuation or dispensing position. Advantageously, the pump also includes a closure member 40 that is disposed upstream from the dispenser orifice 1 and that is adapted to close the orifice when the pump is not in use. The closure member 40 is movable between a closed position in which it co-operates with the dispenser orifice 1 in order to close it, and a non-closing position in which it is moved away from said dispenser orifice 1. En the rest position, the closure member is urged elastically towards its closed position, in particular by means of the return spring 70 of the pump, as shown in the drawings. In a variant, a specific spring could be assigned to said closure member 40.

The swirl chamber of the spray profile is of volume that is substantially zero in the closed position, the movement of the closure member 40 towards its non-closing position creating a volume that forms the swirl chamber. However, other embodiments may also be envisaged.

The pump shown in the figures includes a second piston 57 that slides in leaktight manner in the pump body 52. The second piston 57 is adapted to co-operate with the closure member 40 in order to move it towards its non-closing position, preferably once the pump has been actuated. This provides a certain number of advantages. This configuration enables the closure member 40 to be opened mechanically regardless of the pressure of the fluid in the pump during actuation. In addition, this configuration enables the closure member to be opened at the very end of actuation, thereby guaranteeing that the entire dose is dispensed.

Said rigid insert 30 is preferably secured to said first piston 51. The insert 30 is preferably formed by said first piston 51, i.e. the two parts are made integrally as a single piece. This makes it possible to use one part fewer than in known pumps. The first piston 51 preferably includes a through passage 55 that is made in a wall of said first piston 51 and that is adapted to enable the fluid to pass from the inside of said first piston 51 to the outside of said first piston 51. When the first piston 51 forms the insert 30 that is adapted to define the spray profile at the dispenser orifice 1, the fluid must flow to the outside of said insert, between the outside surface of said insert 30 and the inside surface of the body 11 of the head 10. Advantageously, the first piston 51 is stationary relative to the dispenser head 10, and said closure member 40 slides inside said first piston 51. In this way, the shape of the spray profile remains unchanged, in particular in its non-radial channels, whatever the position of the closure member 10.

In the invention, the pump chamber 56 is connected to the reservoir 100 at the end of each actuation, i.e. when the first piston 51 arrives in its dispensing position. This makes it possible to equalize the pressures between the reservoir and the pump chamber, thereby avoiding too great an increase in pressure that could prevent the pump from functioning properly.

The figures show an advantageous variant of the pump, in which the pump body 52 comprises three axial sleeves, an outer first axial sleeve 52′, a second axial sleeve 52″, and an inner third axial sleeve 52″. Advantageously, the first piston 51 slides in leaktight manner along the inside surface of the outer first axial sleeve 52′. The first piston 51 preferably forms a tubular wall that is also adapted to co-operate with the axial sleeve 52″. Advantageously, it is the top edge of said second axial sleeve 52″ that slides over the inside surface of said first piston 51. This co-operation is leaktight, except when the first piston 51 arrives in its dispensing position, in which position the top edge of the second axial sleeve 52″ no longer co-operates in leaktight manner with said first piston, enabling connection between the pump chamber 56 and the reservoir 100. For example, the inside surface of the first piston 51 may include a small recess that causes the loss of sealing. The second piston 57 preferably includes an outer wall 57′ and an inner wall 57″. The outer wall 57′ is adapted to co-operate in leaktight manner with the inside surface of the second axial sleeve 52″, while the inner wall 57″ co-operates in leaktight manner with the inner third axial sleeve 52″ of the pump body 52, preferably with the inside surface of said inner third axial sleeve, as shown in the figures.

Advantageously, the return spring 70 of the pump is disposed between the second piston 57 and the second and third axial sleeves 52″ and 52″ of the pump body 52, such that it is disposed out of contact with the fluid, avoiding any risk of contamination of the fluid by the metal of the spring.

The pump body 52 of the invention thus has a structure that is complex, but easily achievable by molding, and that makes it possible to perform the advantageous functions of the invention.

The present invention thus makes it possible, with a limited number of parts, in particular the head 10, the first piston 51 (forming the insert 30), the closure member 40, the second piston 57, the spring 70, and the pump body 52, to perform the following functions:
operating reliably without risk of the pump becoming blocked as a result of too great an increase in pressure;
isolating the spring completely relative to the fluid;
spraying the fluid properly while it is being dispensed, as a result of the shape of the spray profile not being modified by the closure member 40 moving towards its non-closing position; the piston 51 forming the insert 30 is advantageously stationary relative to said body 11, such that the shape of the spray profile, and in particular of the non-radial channels, remains unchanged during dispensing;
closing the dispenser orifice completely when the pump is not in use; the closure member 40 may come to co-operate directly with the dispenser orifice 1 by being urged elastically by the return spring of the pump towards its closed position, thereby preventing any germs or bacteria penetrating inside the device between two actuations, and thereby significantly minimizing the risks of contaminating the fluid to be dispensed; and
guaranteeing that the entire dose is dispensed on each actuation; the closure member may be opened at the very end of actuation, and may be opened mechanically by the second piston of the pump; this ensures that the pump is pre-compressed completely during actuation thereof, so that when it opens, the entire dose is guaranteed to be dispensed.

The present invention is described above with reference to an advantageous embodiment thereof, but naturally various modifications could be applied thereto without going beyond the ambit of the present invention, as defined by the accompanying claims.

1. A fluid dispenser device comprising:
a reservoir (100);
a pump (50) including a pump body (52) that defines a pump chamber (56);
a first piston (51) that slides in said pump body (52) between a non-dispensing position and a dispensing position;
a spray head (10) that is mounted on said pump (50) and that is movable manually between a rest position, in which said first piston (51) is in a non-dispensing position, and an actuated position, in which said first piston (51) is moved towards its dispensing position, said spray head (10) including a body (11) that defines an expulsion channel (12) and that is provided with a dispenser orifice (1);
a closure member (40) that is disposed in said expulsion channel (12) of the spray head (10), upstream from the dispenser orifice (1), said closure member (40) being movable between a closed position, in which it co-operates with said dispenser orifice (1) in order to close it, and a non-closing position, in which it is moved away from said dispenser orifice (1), said closure member (40) being urged towards its closed position in the rest position of said spray head (10);
a second piston (57) that slides in said pump body (52), said second piston (57) co-operating with said closure member (40) in order to move it towards its non-closing position;
the device being characterized in that, in the dispensing position of the first piston (51), said pump chamber (56) is connected to the reservoir (100) in order to equalize the pressures after each actuation.

2. A device according to claim 1, wherein, upstream from said dispenser orifice (1), said body (11) of the spray head (10) includes a spray profile that is adapted to spray the fluid while it is being dispensed, said spray head (10) including a rigid insert (30) that is disposed upstream from said spray profile and having an end surface that forms, at least in part, the end wall of said spray profile, said rigid insert (30) being secured to said first piston (51).

3. A device according to claim 2, wherein said rigid insert (30) is made integrally with said first piston (51).

4. A device according to claim 1, wherein said first piston (51) includes at least one through passage (55) enabling the fluid to pass from the inside to the outside of said first piston (51).

5. A device according to claim 1, wherein said closure member is disposed inside said first piston (51), in particular in slidable manner.

6. A device according to claim 1, wherein said second piston (57) co-operates with said closure member (40) at the end of actuation, when said spray head (10) arrives in its actuated position.

7. A device according to claim 1, wherein said first piston (51) is stationary relative to said spray head (10).

8. A device according to claim 1, wherein the pump (50) includes a return spring (70) that is disposed out of contact with the fluid.

9. A device according to claim 1, wherein the pump body (52) includes an outer first axial sleeve (52′) and a second axial sleeve (52″), said first piston (51) co-operating in leaktight manner firstly with the inside of said outer axial sleeve (52′), and secondly with the outside of said second axial sleeve (52″).

10. A device according to claim 9, wherein said top edge of said second axial sleeve (52″) slides in leaktight manner against the inside surface of said first piston (51) until it reaches the dispensing position of said first piston (51), in which position said second axial sleeve (52″) no longer co-operates in leaktight manner with said first piston (51), thereby connecting the metering chamber (56) to the reservoir (100).

11. A device according to claim 9, wherein said pump body (52) includes an inner third axial sleeve (52′″), said second piston (57) co-operating in leaktight manner firstly with the inside of said second axial sleeve (52″), and secondly with said inner third axial sleeve (52′″).

12. A device according to claim 11, wherein the return spring (70) of the pump is disposed between said second piston (57) and said second and third axial sleeves (52″, 52′″) of the pump body (52).

13. A device according to claim 11, wherein said second piston (57) includes an outer wall (57′) that co-operates in leaktight manner with the second axial sleeve (52″) of the pump body (52), and an inner wall (57″) that co-operates in leaktight manner with the inner third axial sleeve (52′″) of the pump body (52), preferably inside said inner third axial sleeve.
